(19) United States
(12) Patent Application Publication
(10) Pub. No.: US 2022/0283363 A1
(43) Pub. Date: Sep. 8, 2022

(54) OPTICAL FIBER WITH REDUCED ATTENUATION DUE TO REDUCED ABSORPTION CONTRIBUTION

(71) Applicant: CORNING INCORPORATED, Corning, NY (US)

(72) Inventors: Stephan Lvovich Logunov, Corning, NY (US); Pushkar Tandon, Painted Post, NY (US)

(21) Appl. No.: 17/679,805

(22) Filed: Feb. 24, 2022

Related U.S. Application Data
(60) Provisional application No. 63/155,935, filed on Mar. 3, 2021.

(51) Int. Cl. G02B 6/02; C03B 37/027

(52) U.S. Cl. CPC G02B 6/02395; G02B 6/02014; G02B 6/02019; C03B 37/027

(57) ABSTRACT

A single mode optical fiber including a core region doped with an alkali metal. The optical fiber has a total attenuation at 1550 nm of about 0.155 dB/km or less such that extrinsic absorption in the optical fiber contributes to 0.004 dB/km or less of the total attenuation

This Application claims the benefit of priority to U.S. Provisional Patent Application Ser. No. 63/155,935 filed on Mar. 3, 2021, the content of which is relied upon and incorporated herein by reference in its entirety.

### FIELD OF THE DISCLOSURE

This disclosure pertains to optical fibers. More particularly, this disclosure pertains to optical fibers with reduced attenuation and with reduced absorption contribution to the attenuation.

### BACKGROUND OF THE DISCLOSURE

Optical fibers have acquired an increasingly important role in the field of communications and operate by propagating a beam of light. Typically an optical fiber comprises a core and cladding. The core is used to propagate the light, and the cladding is used to contain the light within the core through reflection. Impurities and defects in the core are critical since such impurities and defects can hinder the propagation of the light, resulting in loss of light through the fiber and, therefore, a decrease in distance that the light can propagate without requiring amplification.

Attenuation is the loss of a signal within the optical fiber due to external or internal factors. The attenuation of an optical fiber is a result of the fiber's absorption, scattering properties, and bending losses, which are each influenced by the materials of the fiber and the fiber structure itself. Absorption can be caused by extrinsic and/or intrinsic factors. Extrinsic absorption includes atomic defects in the glass composition, such as atoms that are displaced and are not in the proper place in a crystal lattice structure. Extrinsic absorption also includes impurities in the glass material. Intrinsic absorption is caused by the basic constituent atoms of the fiber material, such as the inherent absorption of the material of the optical fiber itself. For an optical fiber formed of fused silica, for example, intrinsic absorption losses relate to absorption of the fused silica itself, whereas extrinsic absorption losses are caused by impurities and/or defects within the fused silica.

Optical fibers must operate with very specific waveguide parameters, including low attenuation loss, in order to transmit a signal over long distances and within a short period of time.

### SUMMARY

Typically, in the process of manufacturing an optical fiber, an optical fiber preform is first produced from a soot blank. For example, using a vapor deposition method, the soot blank is formed by depositing layers of silica-containing soot onto a rotating deposition surface. The soot blank is then dried in a consolidation furnace in a drying gas atmosphere. Once dried, the soot blank may be doped to raise or lower the refractive index of one or more portions of the soot blank, as compared to pure silica. Once the soot blank is sufficiently doped, the soot blank is heated to an elevated temperature until the soot blank vitrifies and produces a consolidated glass preform. The preform is then drawn into an optical fiber using a draw furnace.

Impurities may potentially be introduced during any stage of the manufacturing process. For example, a process gas in the consolidation furnace may include one or more impurities that may be absorbed by the optical fiber preform and incorporated into the drawn fiber. Such may increase the attenuation in the drawn optical fiber, which hinders the propagation of light within the drawn fiber.

In the early stages of the fiber manufacturing process, impurities tend to be highly concentrated and localized in certain areas of an optical fiber preform, thus making it easier to screen the preform to detect such portions of the preform with increased absorption.

Additionally, defects in the optical fiber structure may also increase attenuation. For examples, portions of an optical fiber preform with structural defects in the silica or doped silica network may increase the attenuation of the drawn optical fiber.

Aspects of the present disclosure include a screening process to screen the optical fiber preform, before it is drawn into an optical fiber, for localized areas of increased absorption due to impurities and/or defects and to remove such areas before the drawing process. This advantageously improves the attenuation of the optical fiber drawn therefrom. In some embodiments, a first preform is screened to determine which stage(s) the impurities and/or defects are introduced during the production of the first preform. The localized areas with such impurities and/or defects are then removed from subsequent preforms during the production of the subsequent preforms. Thus, the attenuation of the optical fibers drawn from the subsequent preforms is greatly improved.

The removal of the localized areas may comprise an etching process. As discussed further below, the etching can take place on an un-collapsed preform or on a partially collapsed preform. During the etching step, etchant gases are flowed through a central opening of the preform and/or around an exterior surface of the preform to remove deposited material from the preform. In other embodiments, the preform is exposed to a reagent to treat the localized areas.

In a first aspect, the present disclosure includes a single mode optical fiber comprising a core region comprising silica glass doped with an alkali metal. The optical fiber has a total attenuation at 1550 nm of about 0.155 dB/km or less such that extrinsic absorption in the optical fiber contributes to 0.004 dB/km or less of the total attenuation.

In another aspect, the present disclosure includes a method of making an alkali doped silica core optical fiber, the method comprising determining one or more portions with increased extrinsic absorption in a first optical fiber preform as compared to a baseline of pure silica that is free of any impurities and defects. The method further includes determining one or more production steps, in a production process of the first optical fiber preform, that contribute to the one or more portions with increased extrinsic absorption in the first optical fiber preform. Additionally, the method includes treating one or more portions in a second optical fiber preform made from the same production process as the first optical fiber preform and drawing the second optical fiber preform into an optical fiber, wherein the optical fiber has a total attenuation at 1550 nm of about 0.155 dB/km or less such that extrinsic absorption in the optical fiber contributes to 0.004 dB/km or less of the total attenuation.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIGS. 1A and 1B are schematic views of a process to form an optical fiber preform, according to embodiments of the present disclosure;

FIG. 2 depicts a process to form an optical fiber with reduced attenuation, according to embodiments of the present disclosure;

FIGS. 3A and 3B are schematic views of an optical fiber preform comprising a portion with increased absorption, according to embodiments of the present disclosure;

FIG. 4 is a schematic view of a process to screen an optical fiber preform, according to embodiments of the present disclosure;

FIG. 5 depicts a plot of radial position vs. absorption for a portion of an optical fiber preform, according to embodiments of the present disclosure;

FIG. 6 depicts a plot of radial position vs. attenuation loss for two optical fiber samples, according to embodiments of the present disclosure; and

FIG. 7 depicts a process to form an optical fiber with reduced attenuation, according to embodiments of the present disclosure.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:

“Optical fiber” refers to a waveguide having a glass portion surrounded by a coating. The glass portion includes a core and a cladding and is referred to herein as a “glass fiber”.

“Radial position”, “radius”, or the radial coordinate “r” refers to radial position relative to the centerline (r=0) of the fiber.

“Refractive index” refers to the refractive index at a wavelength of 1550 nm, unless otherwise specified.

The “mode field diameter” or “MFD” of an optical fiber is defined in Eq. (1) as:

$$MFD = 2 w \\ {w}^{2} = 2 \frac{{\int }_{0}^{∞} {( f ( r ) )}^{2} rdr}{{\int }_{0}^{∞} {( \frac{df ( r )}{dr} )}^{2} rdr} \qquad ( 1 )$$

where f(r) is the transverse component of the electric field distribution of the guided optical signal and is calculated from the refractive index profile of the fiber, as is known in the art, and r is radial position in the fiber. “Mode field diameter” or “MFD” depends on the wavelength of the optical signal and is reported herein for wavelengths of 1310 nm and 1550 nm. Specific indication of the wavelength will be made when referring to mode field diameter herein. Unless otherwise specified, mode field diameter refers to the LP₀₁ mode at the specified wavelength.

“Effective area” of an optical fiber is defined in Eq. (2) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 2 )$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm.

The term “attenuation,” as used herein, is the loss of optical power as the signal travels along the optical fiber. Attenuation is measured as specified by the IEC-60793-1-40 standard, “Attenuation measurement methods.”

“Cable cutoff wavelength,” or “cable cutoff,” as used herein, refers to the 22 m cable cutoff test as specified by the IEC 60793-1-44 standard, “Measurement methods and test procedures—Cut-off wavelength.”

The optical fibers disclosed herein include a core region and may further include a cladding region surrounding the core region and a coating surrounding the cladding region. The core region and cladding region are each formed of glass. The cladding region may include multiple concentric regions. In some embodiments, the multiple regions include one or more trench regions comprising a depressed-index cladding region. The coating may include at least a primary coating and a secondary coating. Furthermore, the optical fibers disclosed herein may be single-mode optical fibers or multi-mode optical fibers. As discussed further below, the optical fibers disclosed herein are formed from an optical fiber preform using a draw process.

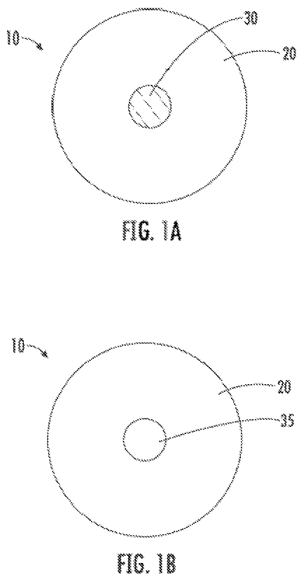

FIGS. 1A and 1B depict a process to from an optical fiber preform using an outside vapor deposition (OVD) method. As shown in FIG. 1A, first a soot deposition layer of silica oxide 20 is deposited on a substrate rod 30 followed by removal of rod 30 to form a glass tube 10. As shown in FIG. 1B, the removal of rod 30 forms a hole or opening 35 (also referred to the centerline hole) in the glass tube. The silica oxide 20 is then consolidated into a silica tube by sintering it and may be further doped with one or more dopants such as, for example, an alkali metal oxide as discussed further below

In accordance with embodiments of the present disclosure, an alkali-doped optical fiber is produced by diffusing an alkali metal oxide into a silica glass tube (e.g., glass tube 10), which is a precursor to optical fiber preform. The consolidated glass tube is alkali doped using the process described below. For example, the glass tube is first mounted between chucks in a lathe, with an annular reservoir for receiving an alkali metal source compound formed near one end of the glass tube by forging two annular neck-like deformations in the wall of the glass tube by flame working or otherwise welding the reservoir to the glass tube. It is also contemplated that other types of reservoirs may be used. Preferably, to prevent crystallization of the alkali metal, the glass tube and any additional glass deposited on the inside of the glass tube is “essentially chlorine free.” By “essentially chlorine free” it is meant that the chlorine content is sufficiently low that optical losses due to alkali chloride crystallization are avoided. In some embodiments, the glass tube has a chlorine content of less than about 500 ppm by wt., or less than about 100 ppm by wt., or less than about 50 ppm by wt.

Furthermore, the silica glass tube, and any additional glass deposited therein, should be “essentially free of water” such that “water” refers to the hydroxyl group OH. Water is responsible for an absorption peak at or about 1383 nm, which may extend into the operating wavelength regions of an optical fiber. This peak may have a detrimental effect on the fiber attenuation. Therefore, it is desirable to reduce the absorption peak, also referred to as the water peak, by reducing the OH content of the glass tube as much as possible. Preferably, the glass tube contains less than about 100 ppb by wt. OH, and more preferably less than about 20 ppb by wt.

To ensure that the glass tube is essentially free of water prior to diffusing the alkali metal oxide dopant, conventional chlorine drying techniques may be employed during manufacture of the glass tube. An alkali source compound is then introduced into the glass tube at the reservoir end and heated by a heat source to form a vapor as the glass tube is rotated. Oxygen gas or a carrier gas is then flowed into an inlet of the glass tube (e.g., through opening 35), and a portion of the glass tube downstream of the alkali metal oxide source compound is heated to facilitate diffusion of the alkali metal oxide into an interior surface of the glass tube. The portion of the glass tube downstream of the alkali metal oxide source compound is heated to a temperature sufficient to promote rapid diffusion of the alkali metal into the interior surface of the glass tube and to prevent devitrification of the glass. Preferably, the portion of the glass tube is heated to a temperature above about 1500° C., and more specifically between about 1500° C. and about 2000° C. The heat source traverses along the length of the portion of the glass tube.

The alkali metal oxide source compound comprises potassium (K), sodium (Na), lithium (Li), caesium (Cs), rubidium (Rb), or combinations thereof. Additionally or alternatively, the alkali metal oxide source comprises bromide, iodide, fluoride, or combinations thereof. Some exemplary compounds for the alkali metal oxide include KBr, KI, KNO₃, K₂O, Na₂O, Li₂O, Rb₂O, and Cs₂O. The alkali metal oxide diffuses to a depth of between about 100 microns and 500 microns from the inside diffusion surface of the glass tube prior to collapse of the glass tube. In some embodiments, the diffused alkali metal oxide dopant concentration (in wt. %) in the glass tube varies radially within the glass tube. For example, the glass tube is doped such that the concentration of the alkali metal oxide is relatively higher in a radially inner half portion of the glass tube and relatively lower in a radially outer half portion of the glass tube. The demarcation point between the inner and outer half portions is defined by and located at half the radial thickness of the glass tube. For example, the diffusion is preferably such that the peak concentration (in wt. %) of the alkali metal oxide in the radial outer half portion is less than 50% of the peak concentration (in wt. %) of the alkali metal oxide in the radial inner half portion.

The diffusion process may be followed by the step of further heating the glass tube to collapse the glass tube, according to conventional methods known in the art. After the collapse step, the doped glass rod is heated in a redraw furnace and drawn into a smaller diameter glass rod at a rate of about 15 cm/min to about 23 cm/min. The drawn small diameter glass rod has an outer diameter in the range of about 3 mm to about 10 mm, or in the range of less than about 6 mm

Furthermore, the small diameter glass rod should have a peak concentration of between about 5 times and 10 times the peak K₂O concentration desired in the core of the optical fiber when the optical fiber is drawn, to offset the significant migration of the alkali dopant during draw of the fiber. For example, if the peak K₂O concentration in the optical fiber core is desired to be 0.4 wt. %, the small diameter glass rod should have a peak K₂O concentration between about 2 wt. % and 4 wt. %. It should be recognized that for large amounts of material added to the doped clad, the peak concentration in the fiber could be 100 times less than the peak concentration in the small diameter glass rod. The small diameter glass rod is further overclad to form the optical fiber preform, which is drawn into an optical fiber.

For example, as shown in FIGS. 1A and 1B, the small diameter alkali-doped glass rod 10 may be used as a starting rod upon which additional porous glass soot is deposited as outer core layer and overclad layer using an OVD method, as is known in the art, to form the optical fiber preform. The preform may also be fluorine doped, as is known in the art. The preform is then consolidated by heating the preform to a suitable temperature for consolidating the preform. The resultant clear glass core preform may then be redrawn to form a second core rod, i.e. a glass rod which contains at least a portion of the core of an optical fiber drawn therefrom. The second core rod may then further processed by adding additional glass, either by sleeving with a glass tube (either a glass tube or soot tube), through depositing glass soot by chemical vapor deposition, for example, by both sleeving and chemical deposition, or through other methods as are known in the art, to form a complete optical fiber preform ready to be drawn into an optical fiber. The additional glass may comprise core glass, cladding glass or both core and cladding glass. Further, the additional glass may take several additional deposition steps to achieve the desired thickness, wherein after each step, the soot is dried, fluorine doped, consolidated and redrawn into a smaller diameter rod.

The outermost cladding of the complete optical fiber preform, which is the cladding adjacent the core, is silica glass that has been sufficiently down doped with fluorine by flood doping. The doping is sufficient to achieve a relative refractive index delta % between the core and the cladding of, for example, greater than 0.2%, and more preferably between 0.30% and 0.50%. In particular, for each additional step wherein moat silica (the additional glass that corresponds to the cladding of the fiber) is added by deposition to the second rod, such moat silica is doped with fluorine. The moat soot is first dried by subjecting it to a chlorine-containing gas, and then exposing it to a fluorine-containing gas (e.g., SiF4 or CF4) for 60-120 minutes at 1225° C. Then, the moat soot is consolidated by downdriving through a hot zone (of 1400-1500° C.) at a rate of 7-10 mm/min, preferably in the presence of the fluorine-containing gas. This preform may be redrawn to form a third rod and the steps repeated again, i.e., deposition, drying, fluorine doping, and consolidation until the proper diameter final preform is achieved. Preferably, the fluorine wt. % in each successive layer of additional glass in the cladding is approximately the same or, more preferably, slightly less (approx. 0.1 to 0.5 wt % less) in the outermost cladding to minimize stress effects.

After the complete optical fiber preform is manufactured, the completed optical fiber preform is drawn into an alkali metal oxide doped optical fiber. The silica glass in the complete optical fiber preform may have a peak alkali concentration in a range from about 10 ppm to about 1000 ppm, or from about 20 ppm to about 800 ppm, or from about 50 ppm to about 500 ppm, or from about 10 ppm to about 300 ppm, or from about 10 ppm to about 250 ppm. Additional methods of forming alkali doped silica optical fibers are disclosed in U.S. Pat. Nos. 7,524,780, 7,469,559, and U.S. Patent Publication No. 2007/0297735, which are each hereby incorporated by reference in their entirety.

In some embodiments, the localized areas of increased absorption (due to impurities and/or defects) in the complete optical fiber preform are incorporated during the processing of the optical fiber preform on the inside or the outside surface of the glass tube or at the surface of any of the subsequent glass layer that are applied on the collapsed tube. These absorbing areas interact with the light launched in the optical fiber to result in increased transmission loss when the fiber is used in a telecommunication system. It is important to identify these areas in the optical preform locations that contribute to increased absorption losses and methods for removing these locations or treating these locations for achieving low attenuation in optical fibers.

As discussed above, the complete optical fiber preform is drawn in a draw furnace. During the drawing of the preform, tension is applied to the preform to maintain the fiber diameter at a predetermined set point. The drawn optical fiber may then be coated with one or more coating layers and then wound on a fiber winding spool.

Once the fiber is drawn, it has a certain attenuation, which dictates the loss of optical power as light travels through the fiber. Embodiments of the present disclosure screen the preform for absorption and remove such portions of the preform before the preform is drawn into the optical fiber, thus lowering the attenuation in the drawn optical fiber.

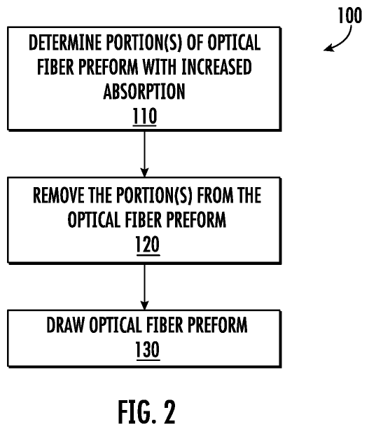

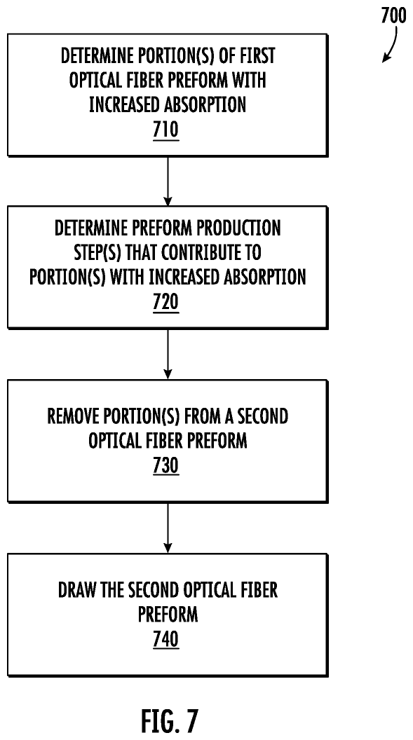

FIG. 2 shows an exemplary process 100 to form an optical fiber with the reduced attenuation, according to the embodiments of the present disclosure. At step 110, the process comprises determining one or more portions of the optical fiber preform with increased absorption. At step 120, the one or more portions are then removed from the optical fiber preform. Then, at step 130, the optical fiber preform is drawn into an optical fiber. As discussed further below, in some embodiments, process 100 comprises determining the portions (in step 110) on the same preform from which the portions are removed (in step 120). However, in other embodiments, such as with reference to FIG. 7, the process comprises determining the portions on a first preform and removing the portions on a second preform. The second preform is then drawn into an optical fiber. As discussed further below with reference to FIG. 7, the processes disclosed herein include identifying, with a first preform, the locations in the preform in which the extrinsic absorbers are added and removing extrinsic absorbers in a second preform that is made with the same process as the first preform.

Furthermore, in some embodiments, process 100 comprises only drawing the optical fiber preform after it is determined that extrinsic absorption is below a predetermined threshold. As also discussed further below, in some embodiments, steps 110 and 120 are repeated during the formation of the optical fiber preform.

At step 110, the preform is screened to determine the one or more portions of the optical fiber preform with increased absorption. The one or more portions with increased absorption may include portions with extrinsic absorption and are determined as compared to a baseline of pure silica fiber that is free of any impurities or defects, as discussed further below. The one or more portions in the preform with increased extrinsic absorption can be caused by (i) defects in the glass compositional structure and/or (ii) impurities in the glass material. Defects in the glass compositional structure include material defects such as structural defects in the lattice structure of the glass material. Impurities in the glass material may potentially be absorbed in the glass material of the optical fiber preform during any stage of the manufacturing process, for example, during doping of a core cane or during consolidation heating of the preform in the presence of a process gas.

It is noted that extrinsic absorption (i.e., defects and impurities in the glass material) is distinct from intrinsic absorption, which refers to absorption caused by the basic composition of the glass material. Stated another way, intrinsic absorption refers to the inherent absorption of the material itself, for example the inherent absorption of silica. In optical fibers, silica is the preferred material because of its inherently low absorption at the wavelengths of operation. For example, at a wavelength of 1550 nm, the intrinsic absorption of silica glass is about 0.015 dB/km.

Embodiments of the present disclosure screen the preform for portions with increased extrinsic absorption caused by (i) defects in the glass compositional structure and/or (ii) impurities in the glass material, as these are not directly related to the inherent material of the glass itself. Thus, these portions of the preform are typically isolated portions that can be screened and detected by comparing the absorption of these portions with other portions of the preform. Defects in the glass compositional structure include, for example, silica defects such as NBO (non-bridging oxygen) and ODC (oxygen deficiency centers). Exemplary impurities include, for example, iron (Fe), titanium (Ti), aluminum (Al), copper (Cu), cobalt (Co), nickel (Ni), manganese (Mn), chromium (Cr), and water vapor.

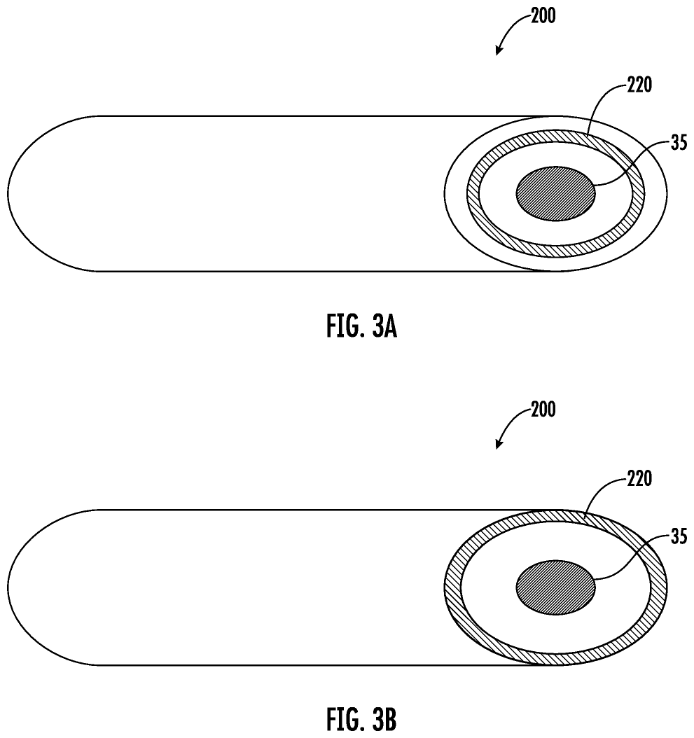

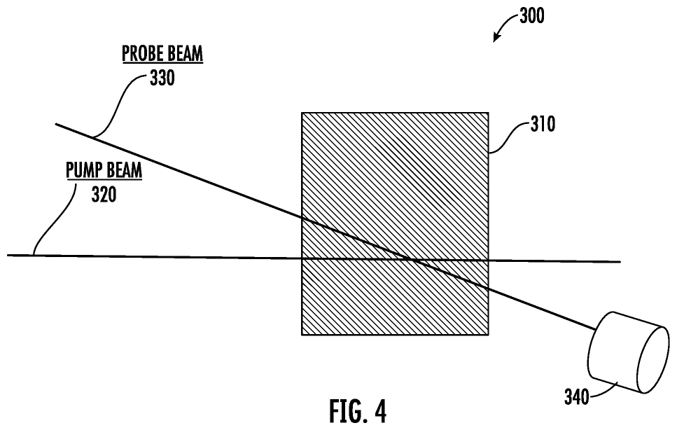

FIGS. 3A and 3B each show an exemplary preform 200 with central opening 35 and a portion 220 with increased extrinsic absorption. In the exemplary embodiments of FIGS. 3A and 3B, portion 220 is depicted as a localized area of preform 200 that comprises an annular ring collinear with a central longitudinal axis of preform 200. In FIG. 3A, portion 220 is located within the bulk of preform 200, such that portion 220 is disposed between outer and inner surfaces of the preform, and portion 220 extends for substantially an entire length of preform 200. In FIG. 3B, portion 220 comprises an outermost surface of preform 200. Although FIGS. 3A and 3B only show only one portion 220, it is also contemplated that preform 200 may comprise two or more portions 220 with increased extrinsic absorption. The portions 220 may comprise separate and discrete portions of the preform or portions that intersect and connect. Furthermore, portions 220 may comprise bulk and/or surface portions of the preform, such as an innermost surface of the preform. In some embodiments, portions 220 are located, at least partially, along a centerline of a collapsed preform. Furthermore, in some embodiments, portions 220 extend for an entire longitudinal length of the preform. In other embodiments, one or more portions 220 extend for a length that is less than the entire longitudinal length of the preform

As discussed above, the one or more portions with increased absorption in the preform are determined in comparison to a baseline. In some embodiments, the baseline is the absorption of a pure silica fiber free of any impurities or defects and the portions with increased absorption have an absorption greater than the baseline absorption. Therefore, in some embodiments, the baseline of extrinsic absorption is 0.00 ppm/cm plus any noise from the measuring devices. As discussed further below, the noise may contribute to about 0.5 ppm/cm of absorption, thus raising the baseline from 0.00 ppm/cm to 0.5 ppm/cm. The one or more portions with increased absorption may have an extrinsic absorption of about 0.05 ppm/cm or more for a wavelength range of 1000 nm to 1600 nm. In some embodiments, the one or more portions have an extrinsic absorption of about 0.1 ppm/cm or more, or about 0.2 ppm/cm or more, or about 0.5 ppm/cm or more, or about 0.7 ppm/cm or more, or about 1.0 ppm/cm or more for the wavelength range of 1000 nm to 1600 nm. Additionally or alternatively, the one or more portions have an extrinsic absorption of about 1.5 ppm/cm or less, or about 1.3 ppm/cm or less, or about 1.1 ppm/cm or less, or about 1.0 ppm/cm or less, or about 0.8 ppm/cm or less, or about 0.6 ppm/cm or less, or about 0.4 ppm/cm or less, or about 0.2 ppm/cm or less for the wavelength range of 1000 nm to 1600 nm.

The baseline of extrinsic absorption may be dependent on the noise of the measuring devices, which may be dependent on the power of the measuring devices. The power is in reference to the power of a pump beam 320, as disused further below with reference to FIG. 4. As also discussed further below, a higher power may produce less noise, which lowers the baseline. For example, a power of 25 Watts may provide a baseline of 0.1 ppm/cm, while a power of 2.5 Watts may provide a higher baseline of 1.0 ppm/cm.

Determining the one or more portions of the optical fiber preform with increased absorption may comprise using a photothermal process. FIG. 4 depicts an exemplary photothermal system 300 to screen a sample of an optical fiber preform 310. In the embodiment, of FIG. 4, system 300 uses a photothermal common-path interferometry (PCI) technique. As shown in FIG. 4, a sample of preform 310 is heated with a pump beam 320 and the resulting increase in temperature of preform sample 310 affects the intersecting probe beam 330. Pump beam 320 is a high power beam and probe beam 330 is a low power beam such that the power of pump beam 320 is greater than the power of probe beam 330.

Pump beam 320 is focused into and absorbed by preform sample 310, which results in local heating of preform sample 310. The rise in temperature of preform sample 310 leads to a local change in the refractive index of the sample. As a result, the localized change in refractive index of preform sample 310 causes the radiation of probe beam 330 to refract within the localized portion of preform sample 310. Thus, probe beam 330 undergoes a phase shift where it intersects with pump beam 320. More specifically, probe beam 330 undergoes a phase distortion due to the change in refractive index of preform sample 310, and the phase distortion of probe beam 330 transforms into an intensity distortion for the beam. A detector 340 detects the resulting intensity change in probe beam 330. The signal detected by detector 340 is proportional to the absorption of the preform sample, as discussed further below.

In some embodiments, detector 340 is a photodiode. The crossing angle between pump beam 322 and probe beam 330 may be about 20° or less, or about 10° or less, or about 7° or less, or about 5° or less, or about 2° or less, or about 0°. Although FIG. 4 shows pump beam 320 and probe beam 330 as traversing preform sample 310 at different angles, it is also noted that pump beam 320 and probe beam 330 may be overlapping and parallel beams that traverse preform sample 310 at the same angle. Furthermore, pump beam 320 may have a power in a range from about 0.5 W to about 100 W, or from about 5.0 W to about 80 W, or about 25 W, or about 30 W, or about 35 W, or about 40 W. As discussed further below, a higher power for pump beam 320 provides a more sensitive detection of the absorption in the preform. Conversely, probe beam 330 may have a much lower power, such as in a range of about 10 mW or less, or from about 0.1 mW to about 30 mW, or from about 3 mW to about 5 mW, or from about 1 mW to about 10 mW.

Preform sample 310 is only a portion of the entire preform but is representative of the entire preform regarding concentration of impurities and defects. Preform sample 310, in some embodiments, has a length of about 10 mm or less, or about 5 mm or less, or about 4 mm or less. However, it is also contemplated, in other embodiments, that preform sample 310 constitutes the entire preform.

As discussed above, detector 340 detects the intensity change in probe beam 330, which results from the temperature increase of preform sample 310. The intensity change of probe beam 330 is then compared to a reference sample of the same material as preform sample 310 and with a known absorption coefficient. Based on this comparison, the absorption of preform sample 310 is derived.

More specifically, a reference sample with a known absorption is first processed by system 300 of FIG. 4, before preform sample 310 is processed by the system. The reference sample is comprised of the same material as preform sample 310. In one example, both the reference sample and preform sample 310 are comprised of silica glass. Furthermore, the absorption of the reference sample was previously determined using a well-known technique (such as spectrophotometry). Therefore, the absorption (A_{ref}) of the reference sample is known before the reference sample is processed by system 300. It is also noted that the reference sample typically has a high absorption (such as about 100 million ppm/cm) so that its absorption can be easily measured. Once the reference sample is placed in system 300, the power of pump beam (P_{ref}) 320 is set so that probe beam 330 undergoes a phase shift and a signal (S_{ref}) is detected by detector 340. The signal of the reference sample (S_{ref}) is used to determine the absorption of preform sample 310, as discussed further below.

Next, the reference sample is removed from system 300 and preform sample 310 is placed in the system for processing. As discussed above, the absorption of preform sample 310 at this time is unknown. The power of pump beam 320 is then changed (e.g., increased) until detector 340 detects an intensity change in probe beam 330, such that a signal (Sₛₐₘₚₗₑ) is detected by detector 340. The absorption of preform sample 310 (Aₛₐₘₚₗₑ) can then be calculated using Eq. (3):

Aₛₐₘₚₗₑ=A_{ref}*(Sₛₐₘₚₗₑ*P_{ref})/(S_{ref}*Pₛₐₘₚₗₑ) (3)

where Aₛₐₘₚₗₑ is the absorption of preform sample 310 (dB/km), A_{ref} is the absorption of the reference sample (dB/km), Sₛₐₘₚₗₑ is the signal detected by detector 340 for preform sample 310, P_{ref} is the power of pump beam 320 for the reference sample, S_{ref} is the signal detected by detector 340 for the reference sample, and Pₛₐₘₚₗₑ is the power of pump beam 320 for preform sample 310. As shown above in Eq. (3), the absorption of preform sample 310 (Aₛₐₘₚₗₑ) is proportional to the product of the signal of preform sample 310 (Sₛₐₘₚₗₑ) and the power of pump beam 320 of the reference sample (P_{ref}). It is noted that the setup parameters (such as the crossing angle between pump beam 320 and probe beam 330 and the power of probe beam 330) remain the same between using the reference sample and preform sample 310. The steps to calculate the absorption of preform sample 310 (Aₛₐₘₚₗₑ) are also discussed in Stanford Photo-Thermal Solutions (2003), www.stan-pts.com, which is incorporated herein by reference.

Using the radial absorption of preform sample 310, the attenuation (dB/km) of the fiber made from this preform can be determined using Eq. 4 below:

$$Attenuation = {\int }_{0 μ m}^{30 μ m} ( Asample ( r ) {f}^{2} ( r ) rdr ) / {\int }_{0 μ m}^{30 μ m} ( {f}^{2} ( r ) rdr ) \qquad ( 4 )$$

where Aₛₐₘₚₗₑ is the absorption of the preform, as calculated above with reference to Eq. (3), f(r) is the transverse component of the electric field of the guided optical signal, which is calculated as discussed above, and r is the radial position within the fiber (microns). It is noted that the attenuation of the preform can be calculated before and/or after removing the portions with increased absorption from the preform (step 120 of process 100). In some embodiments, the calculated attenuation is determined before removing the portions in order to determine if the absorption (and, thus the resulting total attenuation) are suitable for an optical fiber to be used in a telecommunication system. The process of removing the portions with increased absorption is discussed further below.

In some embodiments, if the fiber attenuation calculated from Eq. 4 is above a predetermined threshold, then it is determined that the absorption in the preform is elevated and the preform is not further processed rather than drawn into an optical fiber. Therefore, in some embodiments, process 100 comprises only drawing the optical fiber after determining that the absorption in the preform is below a predetermined threshold. In some embodiments, the optical fiber is only drawn after determining that the total absorption (intrinsic plus extrinsic absorption) in the preform is below a predetermined threshold. In yet other embodiments, the optical fiber is only drawn after determining that the extrinsic absorption in the preform is below a predetermined threshold. For 1550 nm wavelength, intrinsic absorption in a silica-based optical fiber is about 0.015 dB/km so that the threshold for extrinsic absorption should not exceed 0.005 dB/km, and preferably should not exceed 0.004 dB/km.

In yet other embodiments, only the portions with increased absorption are removed from the preform and then the preform is drawn into the optical fiber. The portions with increased absorption are determined in comparison to the baseline, as discussed above.

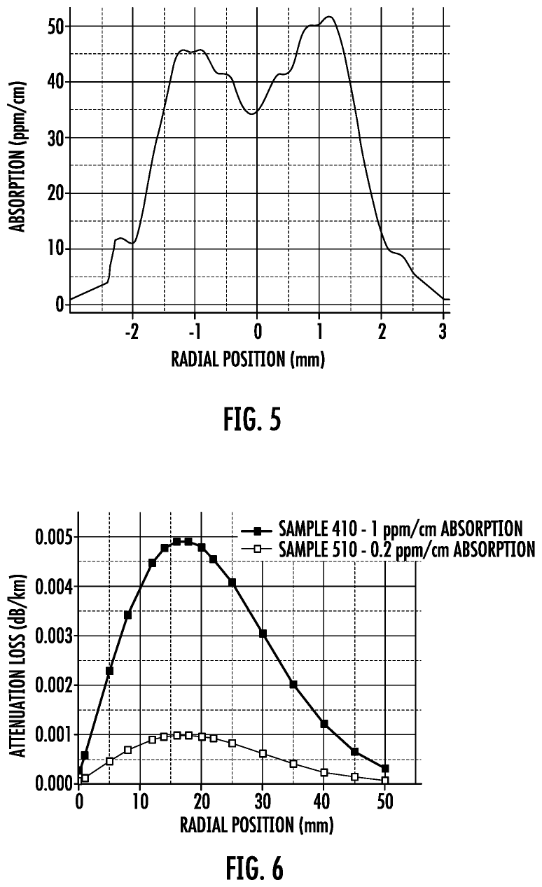

In one example, system 300 measured a distribution of extrinsic absorption (as caused by impurities and defects) in a preform sample along a radial position of the sample at a wavelength of 1550 nm. FIG. 5 depicts a plot of radial position vs. absorption for this example. It is noted that the sample depicted in FIG. 5 only includes a portion of a total cross-section of the preform, and not the entire cross-sectional profile of the preform. In the example of FIG. 5, absorption varies from about 0.8 ppm/cm to about 52 ppm/cm along the radial position of the sample. Therefore, it may be determined that the entire sample depicted in FIG. 5 is above the absorption threshold of 0.005 dB/km so that the entire sample would be determined a portion with increased absorption and removed from the preform.

In one example, a sample of a preform doped with potassium (using potassium-iodide as a precursor) was screened for portions with increased absorption. The sample had a diameter of 15 mm and a length of 6 mm. In this example, pump beam 320 was a YAG laser at 1064 nm with a power of 3 W. Probe beam 330 was a HeNe laser with a power of 1 mW and intersected probe beam 320 at an angle of 5 degrees. The heating by pump beam 320 caused a temperature increase in the sample of about 0.1° C., which therefore caused a change in refractive index of the sample. Such resulted in an absorption calculation of 20 ppm/cm for the sample, which was determined as a portion with increased with absorption.

Although the system of FIG. 4 uses a PCI technique, other systems and processes may be used to determine the absorption in preform sample 310. Other processes include, for example, photothermal blooming, photothermal beam deflection, and direct measurements of the temperature of the sample with thermal camera and thermal interferometry as discussed in Bialkowsi, S. E. (1997) Diffraction Effects in Single- and Two-Laser Photothermal Lens Spectroscopy, Optical Society of America, Vol. 36, No. 27, pgs. 6711-6721; Muhlig, T. W. (2005) Application of the laser induced deflection (LID) technique for low absorption measurements in bulk materials and coatings, Proc. SPIE 5965, Optical Fabrication, Testing, and Metrology II, 59651J; Vlasova, K. V. et al (2018) High-sensitive absorption measurement in transparent isotropic dielectrics with time-resolved photothermal common-path interferometry, Optical Society of America, Vol. 57, No. 22, pgs. 6318-6328; and Alexandrovski, A. L. (1999) Photothermal absorption measurements in optical materials, CWK43, each of which is incorporated herein by reference.

As discussed above, pump beam 320 has a higher power than probe beam 330. The high power of pump beam 320 helps to provide less noise and, thus, a higher sensitivity in determining the absorption due to impurities and defects in the preform. For example, a pump beam 320 with a power of about 25 W provides a sensitivity of about 0.1 ppm/cm. Therefore, the concentration of impurities and defects in the preform can be detected on the order of about 0.1 ppm/cm when using a 25 W pump beam. With a sensitivity of 0.1 ppm/cm, it is assumed that any signal below 0.1 ppm/cm is considered noise from the measuring devices. Therefore, with a sensitivity of 0.1 ppm/cm, the baseline (of which the portions with increased absorption are compared to) increases from 0.00 ppm/cm to 0.1 ppm/cm. A higher level of sensitivity (i.e., more sensitive system) is beneficial in order to determine the absorption with increased accuracy.

In some embodiments, the power of pump beam 320 is chosen so as to provide a sensitivity of about 1 ppm/cm or less (2.5 W from pump beam 320), or about 0.5 ppm/cm or less (5 W from pump beam 320), or about 0.25 ppm/cm or less (10 W from pump beam 320), or about 0.20 ppm/cm or less (12.5 W from pump beam 320), or about 0.10 ppm/com or less (25 W from pump beam 320), or about 0.005 ppm/cm or less (50 W from pump beam). As discussed above, having a more sensitive system allows the resulting attenuation in the drawn optical fiber to be determined with better accuracy. In some embodiments, the attenuation is determined on the order of about 0.1 dB/km or less, or about 0.05 dB/km or less, or about 0.01 dB/km or less, or about 0.005 dB/km or less, or about 0.001 dB/km or less, or about 0.0005 dB/km or less, or about 0.0001 dB/km or less.

As discussed above, absorption in preform sample 310 can result in increased attenuation in the drawn optical fiber. For example, every 1 ppm/cm of absorption in a preform can result in an increase of 0.45 dB/km in the total attenuation of the drawn optical fiber (if the absorption is distributed uniformly through the mode field diameter of the fiber).

FIG. 6 shows the total attenuation loss along the radial position of two preform samples. As shown in FIG. 6, sample 410 has an absorption of 1 ppm/cm and sample 510 has an absorption of 0.2 ppm/cm. Sample 410 has about 5×more impurities than sample 510, thus resulting in the higher absorption for sample 410. Due to its lower absorption, sample 510 has a lower overall attenuation across the radial position of the fiber as compared with sample 410.

It has also been found that if the portion of the preform with increased absorption is localized along a centerline of the preform (along the regions of the preform with the alkali doping), then the resulting effect on the total attenuation is significantly less as compared to if the portion of the preform with increased absorption is located along a portion of the preform that is radially offset from the centerline (along the regions of the preform that are not doped with the alkali metal). For example, an impurity concentration at a radial position of about 15-20 mm may result in a higher extrinsic absorption contribution to the total attenuation than the same impurity concentration at a radial position of about 0 mm. The absorption at the 15-20 mm radial position may be about 2 times or higher, or about 2.5 times or higher, or about 5 times higher than the absorption at the 0 mm radial position. Referring again to FIG. 6, the attenuation of both samples 410 and 510 is highest at about the 16 mm radial position, which is radially offset from the centerline of the preforms.

After screening preform sample 310 in step 110 (of process 100) to determine the one or more portions of the preform with increased absorption, the one or more portions are then modified, such as removed from the preform at step 120. The portions are removed to decrease the attenuation of the drawn optical fiber. In some embodiments, the preform is etched, using a vapor phase etching process, to a depth sufficient to remove the impurities and/or defects in the one or more portions. In other embodiments, the impurities and/or defects are treated with a reagent.

In the embodiments that use an etching process, an aqueous HF solution or a fluoride gas may be used as an etchant. In some embodiments, the fluoride gas is CF₄, SF₆, NF₃, C₂F₆, C4F8, CHF₃, CClF₃, CCl₂F₂, SiF₄, SOF₄, or a mixture thereof. The etchant gas may also include a carrier gas configured to carry the etchant gas. The carrier gas may include oxygen, helium, nitrogen, and/or argon.

The etching can take place on an un-collapsed preform or on a partially collapsed preform. In embodiments, during the etching step, the etchant gas flows through a central opening (opening 35) of the preform to remove material from the inner surface of the preform. Additionally or alternatively, the etchant gas flows along an exterior surface of the preform to remove material from the exterior surface of the preform. Thus, the one or more portions of the preform with increased absorption may be removed from the preform during the etching step.

In some embodiments, the etching step is performed as the preform is being formed. Therefore, after one or more layers of silica soot are deposited on substrate rod 30 (as shown in FIG. 1A) and consolidated, the preform is subjected to the photothermal process of FIG. 4. If it is determined that the preform has absorption above a predetermined threshold, the preform is then etched such that at least one layer of the consolidated glass (or at least one partial layer) is removed from the preform. However, if it determined that the preform has absorption below the predetermined threshold, one or more additional layers of silica soot may be deposited on the preform and consolidated. Then, the preform is subjected to the photothermal process again, and the preform is subsequentially etched if the preform (with the additional layers of consolidated glass) has absorption above a predetermined threshold. And, the process continues until a final preform is formed. Therefore, steps 110 and 120 of process 100 (FIG. 2) are repeated during and intermixed with the process of forming the preform.

During the etching step, the etchant gas may have a flow rate of about 25 standard cubic centimeters per minute (sccm) or more, about 50 sccm or more, about 90 sccm or more, about 150 sccm or more, about 200 sccm or more, about 300 sccm or more, about 500 sccm or more, about 1000 sccm or more, or about 3000 sccm or more. Furthermore, the etchant gas may be heated by an external heat source during the etching step. The temperature of the etchant gas, which contacts the preform, may be about 1700° C. or less, or about 1600° C. or less, or about 1550° C. or less, or about 1500° C. or less, or about 1400° C. or less, or about 1300° C. or less. In some embodiments, the temperature is from about 800° C. to about 1700° C., or from about 1000° C. to about 1600° C., or from about 1200° C. to about 1600° C.

The etchant gas may be passed through or along the preform for a sufficient time to remove a depth of about 100 microns or greater of the preform (from the interior and/or exterior surface of the preform, as discussed above), or about 200 microns or greater, or about 300 microns or greater, or about 400 microns or greater, or about 500 microns or greater, or about 600 microns or greater, or about 700 microns or greater, or about 900 microns or greater. In some embodiments, a depth of about 200 microns to about 1000 microns is removed, or a depth of about 400 microns to about 800 microns is removed from the preform. However, the amount of material removed is dependent upon processing conditions during diffusion and any partial tube collapse. In some embodiments, the etching process removes glass to a depth of at least about 5 percent of the diffusion depth of the alkali metal.

The etching processes disclosed herein may include process parameters such as those disclosed in U.S. Pat. No. 7,524,780 to Ball et al. and U.S. Pat. No. 7,469,559 to Ball et al., each of which is incorporated herein by reference in their entirety.

In embodiments that use a reagent to treat the portions with increased absorption, the consolidated perform may be exposed to a reagent such as a chlorine reagent. Exemplary reagents include, for example, Cl, SOCl₂, and CCl₄. The reagents are configured to diffuse within the depth of the preform to treat the portions with increased absorption. For example, when the portions with increased absorption are due to defects in the glass material, the reagents change the oxidation state of the glass, thus reducing the concentration of these portions in the overall preform. The defects then contribute less to the overall absorption in the preform. As another example, when the portions with increased absorption are due to impurities in the glass material, the reagents chemically react with the impurities. For example, the reagent may convert an impurity to a metal chloride, which diffuses from the preform soot as vapor during the drying step of the preform.

The preform may be exposed to the reagent before consolidation of the glass preform. Furthermore, the reagent treatment step is at a temperature from about 1000° C. to about 1250° C. in a treatment environment with a partial pressure from about 0.005 atm to about 0.1 atm. The concentration of the reagent and the duration of exposure are dependent on the depth of the portion within the preform

As discussed above, the reagents are able to treat the portions with increased absorption that are located within the bulk of the preform. In contrast, the etching process discussed above may be more beneficial to remove specific portions, such as, for example, innermost or outermost surfaces of the preform precursor or intermediate surfaces of the preform.

After the etching and/or reagent steps, the preform may be further processed by adding glass material, either through sleeving with a glass tube, through chemical vapor deposition, or through other means, to form an entire optical fiber preform. This additional glass material may constitute core material, cladding material, or both.

Next, the preform is drawn into an optical fiber in step 130 (of process 100). During the drawing step, the optical fiber is drawn to a predetermined diameter. The various draw parameters (draw speed, temperature, tension, cooling rate, etc.) of the draw process dictate the final diameter of the optical fiber. Furthermore, the optical fiber may be subjected to a coating process in which it is coated with a primary coating, a secondary coating, and, in some embodiments, a tertiary coating.

In some embodiments, a first preform is screened (using the photothermal process of FIG. 4, for example) to determine which stage(s) the impurities and/or defects are introduced during the production of the first preform. The impurities and/or defects are then removed (or treated) from subsequent preforms during the production of the subsequent preforms. Therefore, the first preform is used as a guide for the production of the subsequent preforms. More specifically, and with reference to process 700 of FIG. 7, in step 710, one or more portions with increased absorption are determined in a first preform. For example, it may be determined that the first preform has portions with increased absorption at the 10-11 mm radial position and at the 30-31 mm radial position. Therefore, each of these portions has about a 1 mm radial thickness.

Next, at step 720, the production steps that formed these portions with increased absorption (the 10-11 mm and 30-31 mm radial positions of the first preform) are determined. For example, the production steps may be the deposition of the silica soot at these radial positions or the consolidation of an overcladding layer at these radial positions. It may be determined, for example, that impurities were introduced into the preform production process during these production steps. Therefore, these portions contribute to increased attenuation in the drawn optical fiber and are removed in subsequent preforms

At step 730, one or more portions are removed from a second preform, which uses the same fiber production process as the first preform. The portions removed from the second preform correspond to the portions with increased absorption in the first preform (for example, the 10-11 mm and 30-31 mm radial positions). Therefore, the portions removed from the second preform may also have the same impurities and/or defects as the portions with increased absorption detected in the first preform. The one or more portions may be removed from the second preform as the second preform is being formed. For example, after the deposition of silica soot onto the second preform that corresponds to the 10-11 mm radial position, the second preform is then etched such that the layers of the consolidated glass corresponding to the 10-11 mm radial position are removed from the second preform. One or more additional layers of silica soot are then deposited on the second preform. However, after the deposition of silica soot onto the second preform that corresponds to the 30-31 mm radial position, the second preform is again etched such that the layers of the consolidated glass corresponding to the 30-31 mm radial position are removed from the second preform. One or more additional layers of silica soot are then deposited on the second preform until the preform is fully formed.

Then, the second preform is drawn into an optical fiber at step 740 of process 700. Because the portions with increased absorption were removed from the second preform, the fiber drawn therefrom has reduced attenuation. The first preform may never be drawn into an optical fiber. Instead, this preform may merely be used a guide in order to determine where the impurities and/or defects were introduced and where to etch in the second preform.

Although the above-disclosure of process 700 depicts an embodiment in which the second preform was etched to remove the portions of the preform, it is also noted that process 700 encompasses where the portions of the second preform are treated with a reagent (as discussed above).

Embodiments of the present disclosure screen a preform for portions with increased extrinsic absorption and remove and/or treat those portions before drawing of the preform, therefore the resulting optical fiber has reduced attenuation compared with conventional optical fibers. The total attenuation in the drawn optical fibers of the present disclosure, at a wavelength of 1550 nm, is less than or equal to 0.155 dB/km, or less than or equal to 0.154 dB/km, or less than or equal to 0.153 dB/km, or less than or equal to 0.152 dB/km, or less than or equal to 0.151 dB/km, or less than or equal to 0.150 dB/km, or less than or equal to 0.149 dB/km, or less than or equal to 0.148 dB/km. For example, the total attenuation in the drawn optical fibers of the present disclosure, at a wavelength of 1550 nm, is greater than or equal to 0.140 dB/km and less than or equal to 0.155 dB/km, or greater than or equal to 0.142 dB/km and less than or equal to 0.155 dB/km, or greater than or equal to 0.145 dB/km and less than or equal to 0.155 dB/km, or greater than or equal to 0.146 dB/km and less than or equal to 0.155 dB/km, or greater than or equal to 0.148 dB/km and less than or equal to 0.155 dB/km, or greater than or equal to 0.150 dB/km and less than or equal to 0.155 dB/km.

Due to the screening of the optical fiber preform and removal of the one or more portions with increased absorption, extrinsic absorption in the drawn optical fiber contributes to 0.007 dB/km or less of the total attenuation, or 0.006 dB/km or less of the total attenuation, or 0.005 dB/km or less of the total attenuation, or 0.004 dB/km or less of the total attenuation, or 0.003 dB/km or less of the total attenuation, or 0.002 dB/km or less of the total attenuation, or 0.001 dB/km or less of the total attenuation, or 0.0009 dB/km or less of the total attenuation, or 0.0005 dB/km or less of the total attenuation, or 0.0002 dB/km or less of the total attenuation, or 0.0000 dB/km of the total attenuation. For example, extrinsic absorption in the drawn optical fiber contributes to 0.0000 dB/km or more and 0.007 dB/km or less of the total attenuation, or 0.0002 dB/km or more and 0.007 dB/km or less of the total attenuation, or 0.0005 dB/km or more and 0.007 dB/km or less of the total attenuation.

The total attenuation of an optical fiber (without any induced bending) consists of scattering loss and absorption (both intrinsic and extrinsic). The scattering loss is a combination of Rayleigh, Raman, and Brillouin scattering as well as Small Angle Scattering (SAS). Therefore, the contribution of the extrinsic absorption to the total attenuation can be calculated by determining the total attenuation of the optical fiber, the scattering loss, and intrinsic absorption of the glass material, as shown in Eq. (5) below. It is noted that in Eq. (5), for purposes of the present disclosure, the Rayleigh Scattering Loss is actually a combination of Rayleigh, Raman, and Brillouin scattering losses. However, it is described hereinafter as Rayleigh Scattering Loss since Rayleigh is a dominant contributor to the scattering loss over Raman and Brillouin.

Extrinsic Absorption Contribution=(Total Attenuation)−(Rayleigh Scattering Loss)−(SAS)−(Intrinsic Absorption) (5)

The total attenuation in Eq. (5) is measured using Optical Time Domain Reflectometry (OTDR) method at 1550 nm, as is well known in the art.

The Rayleigh Scattering Loss in Eq. (5) is a combination of Rayleigh, Raman, and Brillouin scattering losses, as discussed above, and is first calculated at the visible wavelength range (400 nm-1000 nm). Based upon this calculation, the Rayleigh Scattering Loss for the infrared wavelength range (1550 nm) is then extrapolated, as discussed further below.

The Rayleigh Scattering Loss α (dB/km) is first calculated at the visible wavelength range (400 nm—1000 nm) using Eq. (6).

α=R/λ⁴ (6)

where R is the Rayleigh coefficient (dB/km/μm⁴), which is measured using the spectral cutback method, as is known in the art, and plotting attenuation vs. the inverse of wavelength to the fourth power over the visible range (400 nm to 1000 nm). The slope of this plot is equal to the Rayleigh coefficient (R). And, the wavelength λ (microns) in Eq. (6) is in the visible range (0.4 microns to 1.0 microns, which is equal to 400 nm to 1000 nm).

The Rayleigh coefficient R in Eq. 6 is over the visible wavelength range and, therefore, represents the Rayleigh coefficient R of the core of the fiber since the light is essentially confined to the core over the visible wavelength range. However, at 1550 nm, the mode field diameter of the fiber is larger and, as a result, a finite amount of light is also is in the cladding. Therefore, the Rayleigh Scattering Loss α calculated in Eq. (6) assumes that the light propagates only within the core of the optical fiber and does not take into account the propagation of light within the cladding. Eq. (7) below determines the Rayleigh Scattering Loss of an optical fiber while accounting for both the propagation of light within the core and cladding. Therefore, Eq. (7) is used to determine the Rayleigh scattering loss at 1550 nm.

$${α}^{′} = \frac{{\int }_{0}^{∞} α ( r ) {( f ( r ) )}^{2} rdr}{{\int }_{0}^{∞} {( f ( r ) )}^{2} rdr} \qquad ( 7 )$$

where α′ is the Rayleigh Scattering Loss at 1550 nm (dB/km/μm⁴), α(r) is the adjusted Rayleigh Scatting Loss (dB/km), as discussed further below, f(r) is the transverse component of the electric field of the guided optical signal, which is calculated as discussed above, and r is the radial position in the fiber. When r is less than or equal to the core radius of the optical fiber, then α(r) is equal to the Rayleigh Scattering Loss α from Eq. (6). When r is greater than the core radius of the optical fiber, then α(r) is equal to the Rayleigh coefficient of the cladding of the optical fiber. In some embodiments, when the cladding is comprised of silica doped fluorine such that the concentration of fluorine is within the range of 0.75 wt. % to 1.2 wt. %, the Rayleigh coefficient of the cladding is about 0.95 dB/km/μm⁴. Therefore, in these embodiments, α(r) is equal to 0.95 dB/km/μm⁴. However, when r is greater than the core radius, it is also known to use other values of α(r) based upon, for example, the concentration of fluorine in the cladding of the optical fiber. As discussed above, the Rayleigh Scattering Loss at 1550 nm (α′) is the total Rayleigh Scattering Loss and is the combination of Rayleigh, Raman, and Brillouin scattering.

The SAS in Eq. (5) is a fraction of total scattering in the optical fiber and provides microstructural information over a very small angular range of the fiber axis. The SAS is measured by placing the optical fiber to be measured in two separate angular scattering measurement setups. The first setup measures a wide-angle component and the second setup measures a small angle component.

The wide-angle setup is comprised of a half cylinder made of high purity fused silica (HPFS). The half cylinder is thoroughly polished on all sides to minimize surface roughness. A flat part of the cylinder is painted black except for a small aperture at the center. The optical fiber under study is stripped of its protective polymer coating and is placed within a groove in a black steel plate. The fiber-steel plate assembly is then covered by the HPFS half cylinder. An index matching gel is used to eliminate an air gap, if any, between the half cylinder and the optical fiber. The angular distribution of scattering is measured by an InGaAs optical detector moving in a semicircular motion in a plane containing the fiber. The wide-angular range measured in this first setup is from 20 degrees to 160 degrees.

An entirely different setup is used for measuring the small-angular range from 0 degrees to 30 degrees. In this setup, the fiber is placed between two HPFS stacked roof prisms, each prism having a first base side angle of 90° and a second base side angle of 135°, the base side angles being measured with respect to a bottom surface of the prisms. The length and the height of the prisms are each 10 cm and 5 cm, respectively. A planoconvex HPFS lens is positioned on top of the upper prism. All air gaps between the two prisms, optical fiber, and the lens are eliminated by the index matching gel. An angled surface of the bottom prism, which is formed by the second base side angle of 135°, is coated with silver so that it is reflective. The light scattered from the fiber is reflected from the angled surface and subsequently refracted by the planoconvex HPFS lens. The InGaAs optical detector is placed at the focal plane of the lens and is scanned along the fiber. Forward and backward angles ranging from 0 to 30 degrees relative to the propagation direction of the light in the fiber are focused onto different locations on the focal plane. The detector directly reads and stores the scattered intensity as a function of distance from the center of the lens.

Next, the data from the first and second setups are plotted as a function of scattering angle (degrees) vs. scattering at 1550 nm (a.u.). In this example, for the fibers disclosed herein, the plotted data from the first and second setups overlap within the angular range of 15 degrees to 30 degrees. It is noted that the data from the two setups discussed above are very different from each other due to different scales at which the measurements were collected. Therefore, scattering within the overlap angular range of 15 degrees to 30 degrees is used to scale the two functions together to build the full scattering function over the range of 0 degrees to 180 degrees. This provides the measured scattering angle function (Ψ(Θ)), which is used below with reference to Eq. (10) to determine the SAS fraction of the total scattering loss.

As is known in the art, total scattering loss of an optical fiber is a sum of the Rayleigh Scattering Loss and SAS. In the processes disclosed herein, the contribution of Rayleigh scattering to the total scattering loss is first calculated in order to then determine the contribution of SAS to the total scattering loss. The contribution of Rayleigh scattering, which is also the Rayleigh scattering component, is calculated over the angular range of 40 degrees to 140 degrees using Eq. (8).

S(Θ)=K*(1+cos²(Θ)) (8)

where S is the Rayleigh scattering component (watts), Θ is the scattering angle relative to light propagation direction (which is over the angular range of 40 degrees to 140 degrees), and K is a fixed coefficient dependent on Rayleigh scattering magnitude.

It is noted that the angular range of 40 degrees to 140 degrees is used in the embodiments disclosed herein because over this angular range, SAS does not contribute to the total scattering loss. Therefore, over this angular range, the total scattering loss is equal to the Rayleigh scattering component (S). After determining the Rayleigh scattering component (S) over the range of 40 degrees to 140 degrees using Eq. (8), the Rayleigh scattering component over the full range of 0 degree to 180 degrees is determined using Eq. (9) below. It is noted that over this full range, both SAS and Rayleigh scattering contribute to the total scattering loss of the fiber.

R0=2π∫₀^{π}S(Θ)sinΘdΘ (9)

where R0 is the integrated function of the Rayleigh scattering contribution to the total scattering loss at 1550 nm, S is the Rayleigh scattering component (watts) as determined above with reference to Eq. (8), and Θ is the scattering angle relative to light propagation direction (which is over the angular range of 0 degrees to 180 degrees).

Next, the total scattering loss is calculated using Eq. (10).

F0=2π∫₀^{π}Ψ(Θ)sin ΘdΘ (10)

where F0 is the integrated function of the total scattering loss (i.e., the combination of Rayleigh Scattering Loss and SAS at 1550 nm) and Ψ(Θ) is the measured scattering angle function as discussed above.

Therefore, the SAS fraction of the total scattering loss is determined according to Eq. (11).

SAS=(F0−R0)/R0 (11)

A further description to calculate SAS can be found in Mazumder, P. et al. (2004) Analysis of excess scattering in optical fibers, Journal of Applied Physics, J. Appl. Phys 96, 4042, which is incorporated herein by reference. The SAS of the optical fibers of the present disclosure varies from about 0.009 dB/km to about 0.0025 dB/km at 1550 nm.

The intrinsic absorption of the glass material is determined according to Eq. (12).

Intrinsic Absorption=1.17*10^12*exp(−50000/λ) (12)

where λ is the wavelength (nm). For alkali doped silica fiber, the intrinsic absorption is 0.015 dB/km at 1550 nm.

An exemplary optical fiber is provided below in Table 1, in which the optical fiber was prepared according to the embodiments of the present disclosure.

TABLE 1

| | | Total | | | Intrinsic | Extrinsic |
|---|---|---|---|---|---|---|
| | Effective | Attenuation | Scattering | | Absorption | Absorption |
| Optical | Area at | Loss at | Loss at | SAS at | Contribution at | Contribution at |
| Fiber | 1550 nm | 1550 nm | 1550 nm | 1550 nm | 1550 nm | 1550 nm |
| Sample | (micron²) | (dB/km) | (dB/km) | (dB/km) | (dB/km) | (dB/km) |
| Example | 115 | 0.146 | 0.125 | 0.0025 | 0.015 | 0.002 |

The optical fibers disclosed herein also have a mode field diameter, at 1310 nm wavelength, in range of about 8.9 microns or greater, or about 9.0 microns or greater, or about 9.1 microns or greater, or about 9.2 microns or greater, or about 9.3 microns or greater, or about 9.4 microns or greater, or about 9.5 microns or greater. In some embodiments, the mode field diameter is in a range from about 8.9 microns to about 9.7 microns, or from about 9.0 microns to about 9.6 microns. For example, the mode field diameter is about 9.07 microns, about 9.08 microns, about 9.23 microns, about 9.26 microns, or about 9.27 microns at 1310 nm wavelength.

Furthermore, the optical fibers disclosed herein have a mode field diameter, at 1550 nm wavelength, in a range of about 10.0 microns to about 10.5 microns, or from about 10.1 microns to about 10.4 microns, or from about 10.2 microns to about 10.3 microns. In some embodiments, the mode field diameter, at 1550 nm wavelength, is about 10.08 microns, or about 10.27 microns, or about 10.48 microns.

The cable cutoff of the optical fibers disclosed herein is about 1600 nm or less, or about 1550 nm or less, or about 1530 nm or less, or about 1300 nm or less, or about 1260 nm or less, or about 1250 nm or less, or about 1240 nm or less, or about 1230 nm or less, or about 1220 nm or less, or about 1210 nm or less, or about 1205 nm or less, or about 1200 nm or less, or about 1195 nm or less, or about 1190 nm or less, or about 1185 nm or less, or about 1180 nm or less, or about 1175 nm or less, or about 1170 nm or less. For example, the cable cutoff is about 1227 nm, about 1226 nm, about 1222 nm, about 1220 nm, about 1218 nm, about 1216 nm, about 1215 nm, about 1205 nm, about 1203 nm, about 1200 nm, about 1180 nm, or about 1176 nm.

Furthermore, the optical fibers disclosed herein have an effective area, at 1310 nm wavelength, of about 70.0 micron² or less, or about 69.0 micron² or less, or about 68.0 micron² or less, or about 67.0 micron² or less, or about 66.0 micron² or less, or about 65.0 micron² or less, or about 64.0 micron² or less, or about 63.0 micron² or less, or about 62.0 micron² or less, or about 61.0 micron² or less, or about 60.0 micron² or less.

The optical fibers also have an effective area, at 1550 nm wavelength, of about 70 micron² or greater, or about 75 micron² or greater, or about 78 micron² or greater, or about 80 micron² or greater, or about 90 micron² or greater, or about 100 micron² or greater, or about 110 micron² or greater, or about 120 micron² or greater, or about 130 micron² or greater. Additionally or alternatively, the effective area, at 1550 nm wavelength, is about 160 micron² or less, or about 150 micron² or less, or about 125 micron² or less, or about 110 micron² or less, or about 100 micron² or less, or about 95 micron² or less, or about 90 micron² or less, or about 85 micron² or less. In some embodiments, the effective area, at 1550 nm wavelength, is in range between about 70 micron² and about 110 micron², or between about 80 micron² and about 95 micron², or between about 100 micron² and about 160 micron².

The optical fibers disclosed herein also have zero dispersion wavelength from about 1290 nm to about 1330 nm. For example, the zero dispersion wavelength can be from about 1295 nm to about 1325 nm, about 1300 nm to about 1324 nm, or from about 1305 nm to about 1315 nm. For example, the zero dispersion wavelength can be about 1280 nm, about 1285 nm, about 1289 nm, about 1290 nm, about 1300 nm, about 1301 nm, about 1305 nm, about 1306 nm, about 1310 nm, about 1315 nm, or about 1320 nm.

According to an aspect of the present disclosure, the optical fibers have a dispersion having an absolute value at 1310 nm in a range between about −3 ps/nm/km and about 3 ps/nm/km and a dispersion slope at 1310 nm in a range between about 0.085 ps/nm²/km and 0.095 ps/nm²/km. For example, the absolute value of the dispersion at 1310 nm can be from about 2 ps/nm/km to about 2 ps/nm/km, about 1.5 ps/nm/km to about 1.5 ps/nm/km, about 1.5 ps/nm/km to about 1 ps/nm/km. For example, the absolute value of the dispersion at 1310 can be about 1.2 ps/nm/km, about 0.1 ps/nm/km, about 0.7 ps/nm/km, about 0.4 ps/nm/km, about 0.2 ps/nm/km, about 0.0 ps/nm/km, about 0.2 ps/nm/km, about 0.4 ps/nm/km, about 0.6 ps/nm/km, about 0.8 ps/nm/km, about 0.9 ps/nm/km, or any value between these values. In one example, the dispersion slope at 1310 nm can be about 0.07 ps/nm²/km to about 0.1 ps/nm²/km, about 0.08 ps/nm²/km to about 0.1 ps/nm²/km, about 0.085 ps/nm²/km to about 0.1 ps/nm²/km, about 0.09 ps/nm²/km to about 0.1 ps/nm²/km, about 0.075 ps/nm²/km to about 0.09 ps/nm²/km, about 0.08 ps/nm²/km to about 0.09 ps/nm²/km, or about 0.085 ps/nm²/km to about 0.09 ps/nm²/km. For example, the dispersion slope at 1310 nm can be about 0.075 ps/nm²/km, about 0.08 ps/nm²/km, about 0.085 ps/nm²/km, about 0.086 ps/nm²/km, about 0.087 ps/nm²/km, about 0.088 ps/nm²/km, about 0.089 ps/nm²/km, about 0.09 ps/nm²/km, or about 0.01 ps/nm²/km.

According to an aspect of the present disclosure, the optical fibers have a dispersion at 1550 nm of less than 22 ps/nm/km and a dispersion slope at 1550 nm of less than 0.1 ps/nm²/km. For example, the dispersion at 1550 nm can be from about 10 ps/nm/km to about 22 ps/nm/km, about 10 ps/nm/km to about 22 ps/nm/km, about 10 ps/nm/km to about 20 ps/nm/km, about 10 ps/nm/km to about 15 ps/nm/km, about 15 ps/nm/km to about 22 ps/nm/km, or about 15 ps/nm/km to about 20 ps/nm/km. For example, the dispersion at 1550 can be about 10 ps/nm/km, about 15 ps/nm/km, about 16 ps/nm/km, about 17 ps/nm/km, about 17.5 ps/nm/km, about 18 ps/nm/km, about 19 ps/nm/km, about 19.5 ps/nm/km, about 19.6 ps/nm/km, about 20 ps/nm/km, about 20.1 ps/nm/km, about 22 ps/nm/km, or any value between these values. In one example, the dispersion slope at 1550 nm can be about 0.04 ps/nm²/km to about 0.1 ps/nm²/km, about 0.05 ps/nm²/km to about 0.1 ps/nm²/km, about 0.055 ps/nm²/km to about 0.1 ps/nm²/km, about 0.06 ps/nm²/km to about 0.1 ps/nm²/km, about 0.08 ps/nm²/km to about 0.1 ps/nm²/km, about 0.04 ps/nm²/km to about 0.08 ps/nm²/km, about 0.05 ps/nm²/km to about 0.08 ps/nm²/km, about 0.055 ps/nm²/km to about 0.08 ps/nm²/km, about 0.06 ps/nm²/km to about 0.08 ps/nm²/km, about 0.04 ps/nm²/km to about 0.06 ps/nm²/km, about 0.05 ps/nm²/km to about 0.06 ps/nm²/km, or about 0.055 ps/nm²/km to about 0.06 ps/nm²/km. For example, the dispersion slope at 1550 nm can be about 0.04 ps/nm²/km, about 0.05 ps/nm²/km, about 0.055 ps/nm²/km, about 0.057 ps/nm²/km, about 0.058 ps/nm²/km, about 0.059 ps/nm²/km, about 0.06 ps/nm²/km, about 0.061 ps/nm²/km, about 0.07 ps/nm²/km, or about 0.08 ps/nm²/km.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A single mode optical fiber comprising:
a core region comprising silica glass doped with an alkali metal,
wherein the optical fiber has a total attenuation at 1550 nm of about 0.155 dB/km or less such that extrinsic absorption in the optical fiber contributes to 0.004 dB/km or less of the total attenuation.

2. The single mode optical fiber of claim 1, wherein the total attenuation is 0.150 dB/km or less at 1550 nm.

3. The single mode optical fiber of claim 2, wherein the total attenuation is 0.148 dB/km or less at 1550 nm.

4. The single mode optical fiber of claim 1, wherein the optical fiber has an effective area, at 1550 nm, between about 70 micron² and about 110 micron².

5. The single mode optical fiber of claim 1, wherein the optical fiber has an effective area, at 1550 nm, of about 90 micron² or less.

6. The single mode optical fiber of claim 1, wherein the optical fiber has an effective area, at 1550 nm, of about 110 micron² or greater.

7. The single mode optical fiber of claim 1, wherein the optical fiber has an effective area, at 1550 nm, between about 100 micron² and about 160 micron².

8. The single mode optical fiber of claim 1, wherein the optical fiber has a cable cutoff of about 1530 nm or less.

9. The single mode optical fiber of claim 8, wherein the cable cutoff is about 1260 nm or less.

10. The single mode optical fiber of claim 1, wherein the extrinsic absorption in the optical fiber contributes to 0.002 dB/km or less of the total attenuation.

11. The single mode optical fiber of claim 10, wherein the extrinsic absorption in the optical fiber contributes to 0.001 dB/km or less of the total attenuation.

12. A method of making an alkali doped silica core optical fiber comprising:
determining one or more portions with increased extrinsic absorption in a first optical fiber preform as compared to a baseline of pure silica fiber that is free of any impurities or defects;
determining one or more production steps, in a production process of the first optical fiber preform, that contribute to the one or more portions with increased extrinsic absorption in the first optical fiber preform;
treating one or more portions in a second optical fiber preform made from the same production process as the first optical fiber preform; and
drawing the second optical fiber preform into an optical fiber,
wherein the optical fiber has a total attenuation at 1550 nm of about 0.155 dB/km or less such that extrinsic absorption in the optical fiber contributes to 0.004 dB/km or less of the total attenuation.

13. The method of claim 12, wherein determining the one or more portions with increased extrinsic absorption in the first optical fiber preform comprises heating the first optical fiber preform with a pump beam and measuring a temperature increase in the first optical fiber preform with a probe beam.

14. The method of claim 13, wherein a power of the pump beam is greater than a power of the probe beam.

15. The method of claim 14, wherein the power of the pump beam is from about 3 W to about 100 W.

16. The method of claim 14, wherein the power of the probe beam is about 10 mW or less.

17. The method of claim 12, wherein the one or more portions with increased extrinsic absorption in the first optical fiber preform have an extrinsic absorption of about 0.1 ppm/cm or more.

18. The method of claim 12, wherein the one or more portions with increased extrinsic absorption in the first optical fiber preform comprise at least one impurity of titanium (Ti), aluminum (Al), copper (Cu), cobalt (Co), nickel (Ni), manganese (Mn), chromium (Cr), and/or water vapor.

19. The method of claim 12, wherein the one or more portions with increased extrinsic absorption in the first optical fiber preform comprise at least one material defect.

20. The method of claim 12, wherein treating the one or more portions in the second optical fiber preform comprises removing portions of the second optical fiber preform produced by the one or more production steps that contribute to the one or more portions with increased extrinsic absorption in the first optical fiber preform.
